(19) United States
(12) Patent Application Publication
(10) Pub. No.: US 2002/0038456 A1
(43) Pub. Date: Mar. 28, 2002

(54) Method and system for the automatic production and distribution of media content using the internet

(76) Inventors: Michael W. Hansen, Yardley, PA (US); Glenn A. Reitmeier, Yardley, PA (US)

Correspondence Address: WILLIAM H. MURRAY, DUANE MORRIS & HECKSCHER LLP, ONE LIBERTY PLACE, PHILADELPHIA, PA, 19103-7396, US

(21) Appl. No.: 09/918,219

(22) Filed: Jul. 30, 2001

Related U.S. Application Data
(60) Provisional application No. 60/234,508, filed on Sep. 22, 2000.
(60) Provisional application No. 60/234,506, filed on Sep. 22, 2000.
(60) Provisional application No. 60/234,507, filed on Sep. 22, 2000.

(51) Int. Cl. G06F 3/00; H04N 5/445; G06F 13/00; H04N 7/173

(52) U.S. Cl. 725/46; 725/91; 725/44

(57) ABSTRACT

A media content capture and distribution system includes at least one capture system which provides clips of media content satisfying a set of at least one trigger defined for the capture system. The clips are transmitted to a distribution system. A channel creator in the distribution system combines a plurality of the clips that satisfy at least a portion of the criteria defining the content requirements of a microchannel into a microchannel stream. The microchannel stream is transmitted to a client through a computer network.

### CROSS-REFERENCE TO RELATED APPLICATIONS

This application claims priority from U.S. provisional application Ser. No. 60/234,508, filed Sep. 22, 2000 and entitled “A Method for the Automatic Production of Video Content Using the Internet”; U.S. provisional application Ser. No. 60/234,506, filed Sep. 22, 2000 and entitled “Server and Distribution System for Internet Video Services Based on Web Cameras”; and U.S. provisional application Ser. No. 60/234,507, filed Sep. 22, 2000 and entitled “A System for Trigger-based Video Capture”, the entirety of which are all hereby incorporated by reference herein.

### FIELD OF THE INVENTION

This invention relates to network-based communication systems and more particularly, to network-based communication systems providing video content.

### BACKGROUND OF THE INVENTION

Transmission of video content over a computer network requires extensive bandwidth. The use of video compression algorithms to reduce the bandwidth requirements has become very common, however, the bandwidth requirements are still quite large. Currently, the lack of widespread broadband data transmission (on the order of 500 kilobits per second or better bidirectional) forces levels of compression that require low frame rates and spatial resolution. As a result, current “web cams” usually act as regular still frame grabbing systems, which can update their video multiple times a minute or less, rather than providing video at a full 60 fields/sec as with broadcast video.

One partial solution to this bandwidth requirement, therefore, is to optimize the actual content of the video with respect to the information provided. If the video content can be selected from a particular time sequence, rather than a continuous time sequence, the bandwidth requirements can be significantly reduced. U.S. Pat. No. 6,166,729 issued Dec. 26, 2000 to Acosta et al. describes a remote viewing system where a camera awaits an actuating event before transmitting compressed images in its queues in part through a wireless network to a central office video management system, which in turn then provides the images to a web server. The web server allows a browser enabled user terminal to access the images.

Although Acosta et al. provides one possible method of improving the video content which is captured and eventually transmitted to a central office video management system, the ability of the system to provide the images to the web server is still highly dependent on the available bandwidth between the camera(s) and the central office video management system, particularly when continuous video is to be provided through the web server. Therefore, there remains a need to selectively generate video content and provide that content to users in an efficient and continuous manner.

Still further, current video content is generally provided on a widespread basis only through broadcast, cable, terrestrial, and satellite means with standard format imagery and some high definition television (HDTV). Broadcast channels are intended for a widespread audience, and contain content that is largely for entertainment and news purposes. Non-broadcast network programming tends to be more specialized and caters to specific genres of content such as home improvement, cooking, world history, animals, music videos, and horse racing, to name a few. The content on these programs are still pre-programmed, but with much smaller production budgets and smaller audiences than broadcast television.

A new category of video, enabled through internet video content delivery when sufficient bandwidth is available, is a “microchannel” of video programming. These channels provide video that cater to very specific viewer interests, such as bird watching, hobbyists, and virtual travel. For these channels, large or even moderate production budgets are difficult to support based on the limited size of the audience. These microchannels generally utilize a single web camera and provide video, such as streamed video, through a website. Such systems, however, do not ensure that the video content is of any interest. In essence, the content of the microchannel is limited to the action (or inaction) currently before the camera.

Potential opportunities for “microchannels,” however, are enormous. There are virtually an infinite number of special interest channels in which an audience may be interested. Since the viewers are specific about their content, there is an opportunity to sharply target products that will be meaningful to those customers. A vendor of birdseed, for example, might not pay for advertisements on any existing broadcast or non-broadcast video channel, but it would provide advertisements for a channel specifically tailored to bird watchers and bird pet owners.

Therefore, in addition to the continued need to selectively generate video content and provide that content to users in an efficient and continuous manner, there remains a need for a method and system that specifically targets video content towards the microchannel audience, using the Internet as a vehicle to distribute the content. Still further, there is a concurrent need for a method of making such a system economically viable.

### SUMMARY OF THE INVENTION

The present invention is a system and method for capturing and distributing media content over a computer network. The system includes at least one capture system which transmits clips of media content captured by the capture system to a distribution system through the computer network. The media content is characterized by trigger criteria identified by a set of at least one trigger which defines for the capture system at least one type of media content to be transmitted to the distribution system. The distribution system receives the clips transmitted from the capture system. The distribution system includes at least one microchannel creator. The microchannel creator combines a plurality of the clips into a microchannel stream. Each of the combined clips is associated with criteria from the trigger criteria that overlap at least a portion of microchannel criteria that define at least one type of media content to be included in the microchannel stream. The microchannel stream may be transmitted to a client through the computer network.

The above and other features of the present invention will be better understood from the following detailed description of the preferred embodiments of the invention which is provided in connection with the accompanying drawings.

### A BRIEF DESCRIPTION OF THE DRAWINGS

The accompanying drawings illustrate preferred embodiments of the invention, as well as other information pertinent to the disclosure, in which:

FIG. 1 is a stylized overview of a system of interconnected computer networks;

FIG. 2 is a stylized overview of an Internet-based video capture and distribution system;

FIG. 3 a stylized overview of a capture system of the system of FIG. 2;

FIG. 4 is a stylized overview of a distribution system of the system of FIG. 2; and

FIG. 5 is a view of an exemplary web page including a viewer window showing video content generated by the system of FIG. 2.

### DETAILED DESCRIPTION OF THE INVENTION

Although the present invention is particularly well suited for use in connecting Internet users and shall be so described, the present invention is equally well suited for use in other network communication systems such as an Intranet, an Interactive television (it) system, and similar interactive communication systems.

The Internet is a worldwide system of computer networks—a network of networks in which users at one computer can obtain information from any other computer and communicate with user of other computers. The most widely used part of the Internet is the World Wide Web (often abbreviated “WWW” or called “the Web”). One of the most outstanding features of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser, the most popular of which presently are Netscape Navigator and Microsoft Internet Explorer. The appearance of a particular website may vary slightly depending on the particular browser used. Recent versions of browsers have “plug-ins,” which provide animation, virtual reality, sound and music.

Although the Internet was not designed to make commercializations easy, commercial Internet publishing and various forms of e-commerce have rapidly evolved. The ease of publishing a documents that is made accessible to a large number of people makes electronic publishing attractive. E-commerce applications require very little overhead, while reaching a worldwide market twenty-four hours a day. The growth and popularity of the Internet is providing new opportunities for commercialization including, but not limited to, Web sites driven by electronic commerce, ad revenue, branding, database transactions, and intranet/extranet applications.

On-line commerce, or “e-commerce”, uses the Internet, of which the Web is a part, to transfer large amounts of information about numerous goods and services in exchange for payment or customers data needed to facilitate payment. Potential customers can supply a company with shipping and invoicing information without having to tie up sales staff. The convenience offered to the customer through remote purchasing should be apparent.

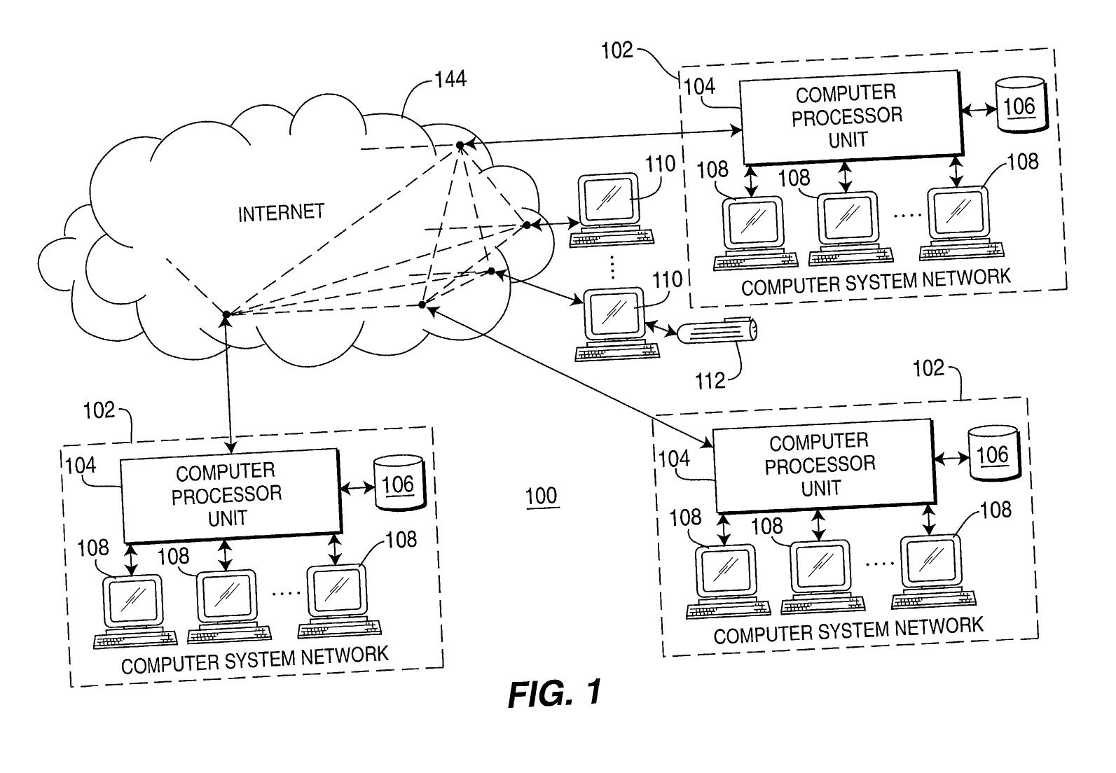

Referring to FIG. 1 there is shown a stylized overview of a system 100 of interconnected computer system networks 102. Each computer system network 102 contains a corresponding local computer processor unit 104, which is coupled to a corresponding local data storage unit 106, and local network users 108. A computer system network 102 may be a local area network (LAN) or a wide area network (WAN) for example. The local computer processor units 104 are selectively coupled to a plurality of users 110 through Internet 114 described above. Each of the plurality of users 110 (also referred to as client terminals) may have various devices connected to their local computer systems, such as scanners, bar code readers, printers, and other interface devices 112. A user 110, programmed with a Web browser, locates and selects (such as by clicking with a mouse) a particular Web page, the content of which is located on the local data storage unit 106 of a computer system network 102, in order to access the content of the Web page. The Web page may contain links to other computer systems and other Web pages.

The user 110 may be a computer terminal, a pager which can communicate through the Internet using the Internet Protocol, a Kiosk with Internet access, a connected electronic planner (e.g., a PALM device manufactured by Palm, Inc.) or other device capable of interactive Internet communication, such as an electronic personal planner. User terminal 110 can also be a wireless device, such as a hand held unit (e.g., cellular telephone) connecting to and communicating through the Internet using the wireless access protocol (WAP).

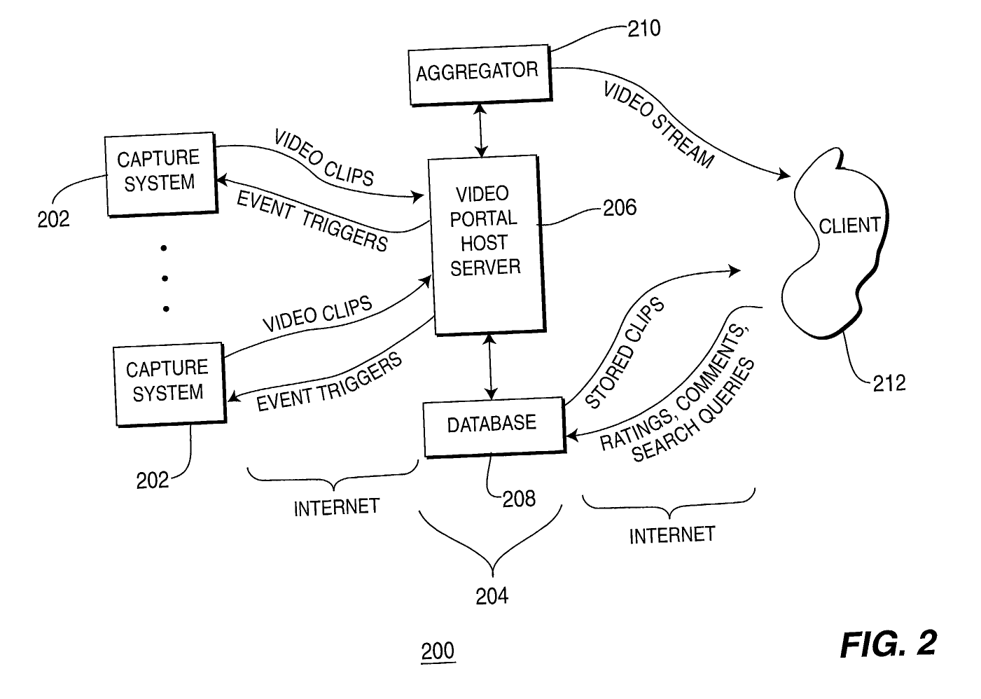

Referring to FIG. 2, there is shown a stylized view of an exemplary embodiment of an Internet video capture and distribution system 200. The system 200 includes a plurality of capture systems 202 connected preferably through the Internet to a video distribution system 204. The video distribution system 204 includes a video portal host server 206. The video portal host server 206 is coupled to a database 208 and a channel aggregation 210. A client 212 is coupled through the Internet to the video distribution system 204.

In one embodiment of the present system, video content is delivered to a client 212 which is a web portal (physically a web server), and preferably a branded web portal. The branded portal provides video services to its customers through video distribution system 204. The services preferably include microchannel delivery and video clip retrieval of video content that is relevant to the interests of the customers of the portal. The branded web portal typically generates revenue through providing shopping, advertising, subscriptions, or other services.

The capture systems 202 provide video clips, still images, and other visual and audio media, along with additional data about the media, to support the aggregation of video information to populate special-interest channels called “microchannels” distributed over the Internet. Each video capture system 202 is preferably capable of detecting specific content that is of interest to the viewing audience of a specific microchannel. The detection of the interesting content triggers the capture system 202 to properly delineate the proper time interval in the video stream where the content is found, compress the content clip, tag the clip with metadata regarding the specific trigger, and notify either an end user or proxy such as a video host server 206 that pulls the content from the capture system and stores it.

The video distribution system 204 provides multiple levels of service. These services preferably include the aggregation of video clips, using concatenation of the video clips, to generate a single video steam that multiplexes the different capture systems' outputs for an always-active video channel(s) for transmission and viewing. The video distribution system 204 also provides a database services through database 208 where certain clips are stored into a database for query and retrieval by viewers. These queries can be by event, by date/time, by location, trigger-based metadata, or through other indexes. Also, the viewer might elect to add information to a video clip such as comments, rankings on the popularity of the clip, factual information about the clip, and so on.

By providing multiple triggers, a single capture system 202 can be designated to provide content for multiple microchannels. This form of triggering and smart capture interaction is invisible to the microchannel viewer. The smart capture systems 202 may also be used to populate the database 208 with content for later retrieval by the viewing clientele. In that instance, triggers are defined as metadata that can later be used as query tools for clientele to search the database 208 for specific content that is of interest. The effectiveness of an individual capture system 202 is, therefore, determined by the system's ability to distinguish between content of interest and content which is uninteresting to the audience. If the capture system provides content that is not of interest to the audience, the channel's content is no longer valuable and the service is not viable. The components of an exemplary video capture and distribution system 200 are described below in more detail.

Although, as described hereafter, video content is the principal focus of the media provided, the capture systems 202 and related microchannel content are not limited to simple video. Other multimedia content, such as video mosaics, 3D visualized and interactive environments, video and audio, and other forms of media are all equally applicable to the disclosure of the described system.

The architecture of each capture system 202 is preferably designed to enable a heterogenous set of Internet connected video cameras to communicate over the Internet, or other computer network, to a video distribution system 204 to provide the specialized video content desired by viewers in the form of microchannels of content. The architectural aspects of the capture system describe the functions that all subscribed capture systems should be capable of in order to be an effective and viable part of the video capture and distribution system 200. Given this, numerous physical implementations of capture systems 202 can exist, including systems that are based on consumer grade “web cameras” and personal computers and specialized systems designed with the smart capture application as the particular focus of the design.

Each capture system 202 includes at least one camera unit 300 and a microprocessorbased, software programmed control unit (not shown) for controlling the camera and communicating with the video distribution system 204 through the Internet. The first function of this software is to subscribe the capture system 202 to the video distribution system 204, thus declaring the capture system 202 to be a potential source of video content. The video distribution system then adds the capture system 202 to a list of subscribed capture systems 202 and interacts with that capture system 202 to retrieve media content for aggregation and dissemination through microchannels.

In an exemplary subscription process, subscription data is preferably transferred to the video distribution system 204 indicating the identity of the capture system 202, the operator of the capture system 202, the location of the camera, the categorization of content gathered by the capture system 202, and the triggering capabilities of the camera system 202. Operator and capture system identification data may be used to attach a corporate or personal affiliation to the capture system 202. This information also identifies the responsible operator or administrator of the capture system 202. This information, in turn, is used to attribute captured content to a single source for revenue purposes and tracking purposes, as well as for providing a given point of contact for problems associated with the capture system 202.

The data that identifies the location of the capture system preferably identifies the city and state of the location of the camera as well as any corporate affiliations associated with the camera, if any. For example, a camera associated with a place of business may subscribe data not only about the physical location of the camera, but also information about the business name as well (assuming the place of business is different from the camera operator identified above in the subscription data). This information can be used for advertising purposes, or for providing convenient hyperlinks for viewers to link directly with the business's website. Other unique geographical identification information may also be utilized, such as global positioning system (GPS) coordinates, longitude and latitude values, etc.

Subscription data also identifies the type of content that is intended to be provided by the camera of the capture system 202. Categories are preferably provided by the video distribution system 204, and the operator of the capture system 202 declares that unit to be a viable source of a particular category of information. Some examples of content may be “bird camera” for cameras that are situated around bird baths and nesting sites (or even specific species), “wildlife cams” for general cameras that view areas where wildlife is expected, “voyeur cams” for indoor cameras that are intended to provide voyeur content, “beach cameras” for providing content based on activity at beach locations, and so forth. Usually implicit within these categorizations are basic indications of the camera environment, e.g., indoor, outdoor, expected viewing distances, etc. If not implicit in the basic categorization of the content, these fields may be explicitly declared by camera operators and transmitted to the video distribution system during the subscription process.

Triggering capability data indicates to the video distribution system 204 the abilities of the capture system 202 to discriminate between content of interest and content that is uninteresting. All capture systems 202 preferably have some sort of triggering capability, which minimally should include motion detection. Many other triggers are possible and, when present, enable additional specificity in the content provided by the capture unit.

The subscription data provides the video distribution system 204 with a basic indication of the content type associated with the capture system 202, and attributions that are to be associated with the content from the capture system 202. The video distribution system 204 uses this information to select which capture systems should provide media content to specific microchannels. A capture system 202 can provide content for multiple categories, depending on the location of the camera and triggering capabilities.

The subscription process is preferably provided through an on-line web form entry means. A subscribed system 202 is provided a specialized “key” access to the video distribution system 204. Any standard S.P. (secure socket protocol) method may be employed. The web camera operator is thereby provided with security for the content provided from its web camera. Through secure transmissions to the video distribution system 204, third parties cannot directly access the data coming from the capture system 202 to the distribution system 202.

The subscription process also enables the operator of video distribution system 204 to enforce any license agreements between the operator and the capture system operator. Subscription, on-line or otherwise, may be used to obligate the capture system operator and video distribution system operator to the terms of a license agreement.

The operation of the system 200 relies on each capture system 202 providing media content only occasionally to the video distribution system 204 when a specific trigger criterion is activated. Continuous transmission to the host server is both difficult to achieve and impractical large amounts of continuous bandwidth are required for continuous transfer, and such continuous transfer is not guaranteed to provide meaningful content at any given time. Rather, the preferred capture systems 202 of this exemplary embodiment send media content only occasionally based on “triggers” that are defined for the camera by the video distribution system 204. There are a variety of different potential triggers, some of which are defined hereafter. Regardless of the trigger though, the capture system 202 preferably captures content, compresses the captured content, and transmits the captured content to the video distribution system 204.

The simplest possible trigger is a time trigger that directs the periodic capture of a still image or video clip and transmission of that clip to the video distribution system 204. Such periodic triggering is useful for generic cameras that are intended to provide coverage over a given area during all times of day, with no additional contextual information required. So-called urban cameras, which grab “slice of life” images and clips of urban areas with no regard to the activity in the scene, are examples where a periodic trigger may be appropriate. This trigger is common in web cameras today, and generally does not provide particularly meaningful information to microchannels of the exemplary embodiment of system 200.

The simplest preferred trigger is a motion detection trigger. The method of motion detection can vary between capture system implementations. Motion detector triggers are effective for indoor voyeur cameras, for example, when clips are to be transmitted only when there is activity within the scene. Triggering capture, compression and transmission based on motion removes a large percentage of the “dead” video from web camera output and enhances the potential content provided within microchannels. Simple motion detection triggers are less useful in outdoor environments, where meteorological, lighting, and other effects can cause false positive motion detection. Motion triggering may be activated by motion detection from scene analysis of captured clips, or may be implemented by an external trigger such as an IR motion sensor commonly used for low-end motion detection systems.

More sophisticated detection and triggering mechanisms provide more functionality and versatility to a capture system 202 and, therefore, to system 200. The most sophisticated, and most useful, form of triggering enables the video distribution system 204 to upload triggers to the controllers of the capture systems 202 in order to define the triggering mechanisms in a dynamic sense. The upload may occur during the subscription process or thereafter. Through the uploaded triggers, it is possible for video distribution system 204 to modify the behavior of an individual capture system 202 unit based on the needs of the microchannel. Of course, the kinds of triggers that may be uploaded to an individual capture system are limited by the abilities of the capture system defined during subscription. This on-demand dynamic feature ensures that the rnicrochannels receive near-optimal amounts of content in real time. As an example, outdoor cameras might be capable of triggering based on humans or vehicles and might provide content for different microchannels depending on the types of triggers that were activated. These triggers may be activated or deactivated based on a dynamic criteria modified in response to a rule and preference based selection criteria.

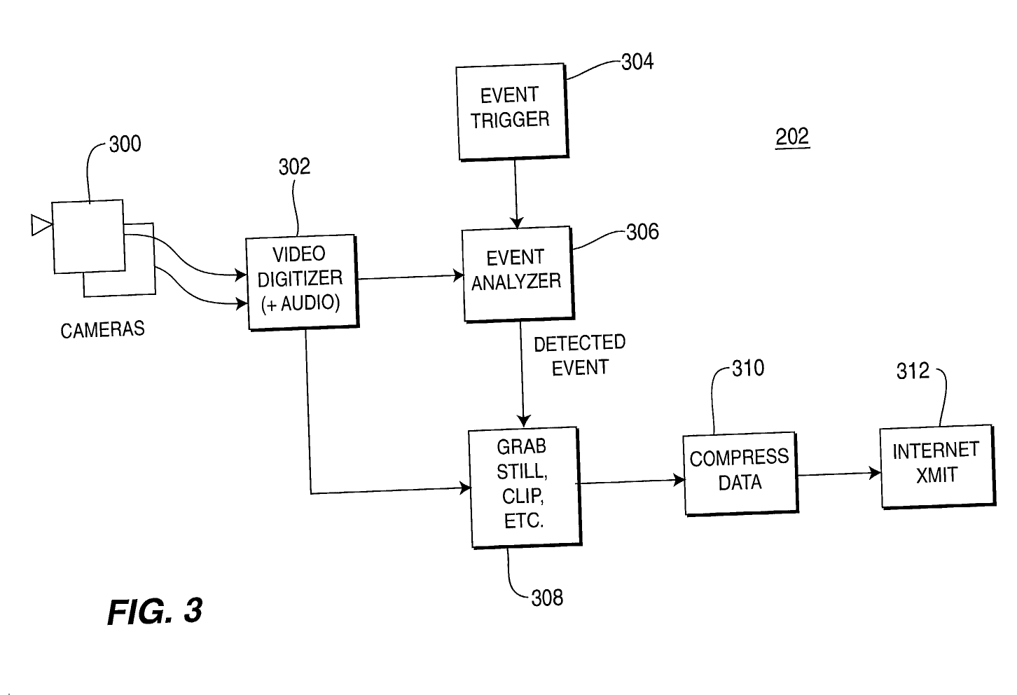

Referring to FIG. 3, there is shown a functional block diagram showing the operation of a capture system 202. A camera 200 captures media content, such as video, which is then digitized at 302. Event triggers are defined at 304 and the digitized media is analyzed at 306 for the occurrence of an event defined by a trigger. If an event is detected (such as detected motion), a still image, video clip or other defined content is taken at 308 from the digitized content of 302. A “clip” may be defined as a duration of time when the triggers that are set for the capture system are activated—such as when there is motion in the scene and the trigger is set to a basic motion cue. The clip preferably ends when the trigger event is no longer detected or when a certain time period expires, although other more sophisticated methods for trigger intervals may also be utilized. Once a clip is delineated, the content is generated. At a minimum, the content includes one still image that represents the trigger event in action. For example, 15 seconds out of one minute of captured content may be identified at 306 as qualifying content. This fifteen seconds of content is taken at 308 and then compressed at 310. The compressed content is then transmitted at 312 through the Internet to video distribution system 204.

Some distinction need to be explained regarding the differences between an event, a characteristic and a trigger. An “event” is detected dynamic activity in a video stream, such as the appearance of an object in the video stream that was not there at a prior time. A “characteristic” is a set of attributes associated with objects, such as the color of the object or the location of the object. A “trigger” is a set of low-level events and characteristics that, when combined, fully described the criteria for interesting content.

A typical low level set of events could include the following: an appearance event where an object enters or appears in a scene; a motion event where a scene object is moving in the scene; a motion discriminated event where a scene object is moving in a given, predefined direction, such as entering or exiting a room; or a disappearance event where an object leaves or disappears from a scene.

There are a large set of characteristics that can be associated with scene objects and their corresponding dynamic events. Some of these characteristics are inherited from the camera capturing the video or are otherwise extrinsic to the object, while others are intrinsic to the objects themselves. Some examples of extrinsic characteristics include the following: date and time the video clip was captured; physical location of the camera in the world; content that is being gathered from the camera, such as outdoor/indoor content, wildlife content, voyeur content, bird-watching content, urban content, beach content, underwater content, vehicle content, to name a few; and event identifiers. When a specific event is being watched, such as a sporting event, user or operator input may be used at the camera site to better indicate the content of the event. For example, an athletic competition being watched by a capture system 202 could have an event identifier like “skateboarding competition” which would then place additional input into the captured video stream about the content of the video.

Intrinsic characteristics are those which the scene objects themselves possess. Examples of intrinsic characteristics include the size of the object in either two dimensional (image, area) or three dimensional (world, volume) measurements, the type of object (e.g., human, vehicle, etc.), color (indicated from a rough color signature of an object's appearance), and texture which defines patterns and frequency-rich visual information about the object.

The motion triggers themselves may be combinations of events and characteristics. One example trigger may be “show me all appearances [i.e., events] from bird cameras [i.e., content] between 7 A.M. and 7 P.M. [i.e., time] in the U.S. Mid-Atlantic Region [i.e., camera location] on objects less than one foot in length [i.e., size] that are dominantly red [i.e., color].” This trigger would instruct capture system(s) 202 to transmit captured content during daylight hours of small, red birds commonly known as cardinals.

One key feature provided by the capture system 202 is the detection of events. Standard web camera systems provide no notion of activity and therefore do not prioritize or even identify output with knowledge of events. Therefore, web cameras usually provide imagery with no activity or interesting content. Even systems that move from camera to camera do not use events as triggers.

It should be noted that there is no specific type of event that is required for the system. Different types of motion detection systems provide different performance. The key attribute is that the video capture system 202 be capable somehow of detecting scene activity and using that scene activity to cue clip capture and transmission to video distribution system 204. Many different methods of event detection may be employed, and these different methods are applicable in different situations.

As mentioned before, and event describes the appearance, disappearance, or other activity of a scene object within the video stream of the video capture system. An appearance event indicates the appearance of an object in a scene when it has not been seen at a prior time. Normally, when the fame rate is high, objects appear gradually as they come into the field of view of the sensor. Other times, when the frame rate of the video sensor is lower, the objects may move into the field of view between frames, thus causing them to “appear” in the video. Disappearance works in a similar but converse fashion—objects in the scene that were seen at one point are not there in later frames.

Detecting appearance events through visual cues (such as changes in scene appearance) tends to be prone to either a high false alarm rate or an overall lack of sensitivity. One method for detecting such appearance events is to build a “background representation” of the scene's appearance through modeling each pixel position as a mixture of Gaussian distributions. Such a representation is built gradually over time through varying methods of scene background learning.

When a set of video frames is seen that do not match the mixture-of-Gaussian distributions in the scene, a video detection is triggered. If the object is fairly new, then this is an appearance event. If the object has been in the scene for quite a while then disappears, then the visual change could be inferred to be a disappearance event. Objects that move through the scene can be tracked through inferring motion from their grayscale change locations over time.

Such methods, while suitable for indoor environments with no illumination variations, are less suitable for general indoor/outdoor use. Changes in ambient illumination, sun and shadow position, clouds passing, leaves blowing, and numerous other visual and motion effects can cause false alarms in such systems. Thus, systems that detect visual changes are good for indoor environments with little or no illumination variations, but these systems are not preferred for outdoor environments.

Many low-cost security and surveillance systems use IR detection for identifying objects in the scene. These systems detect IR signatures of objects in the scene, and trigger a detection when the IR threshold has been exceeded. These systems can be linked with video capture systems for detecting scene activity. Such systems should work well in indoor and outdoor environments with minimal clutter. Like the visual change method, blowing foliage, IR illuminations (such as artificial lighting), and other sources can cause these systems to misfire on activities that are not of interest. Disappearance events can be detected through the lack of an alarm situation. When detection occurs, the presence is maintained until the source of stimulus is removed. This can be inferred as a disappearance event.

Many of the shortcomings of visual change detection are associated with the inference of scene activity from presence of visual change in the scene. A stereo vision method uses two cameras with overlapping fields of view to recover three dimensional information from the scene. This is a well-known method for recovering three-dimensional shapes in a scene and is well described in the literature. Unlike changes in visual appearance, changes in three dimensional shape of the scene are excellent cues for determining activity in the scene. Shadows, changes in illumination, and blowing foliage do not substantially alter the physical structure of the scene. As a result, stereo vision can recover a consistent “background” representation of the scene based on a depth map from stereo that is stable in the presence of varying illumination. Finding differences between this background representation of the three dimensional shape and the current shape of the scene can indicate the position of objects in the scene. Further, it provides real three dimensional information about the size, shape and position of the objects in the scene. In this manner, the physical dimensions of the objects in the scene can be measured. Systems intended to detect people and vehicles can, therefore, suppress motion due to small creatures (e.g., birds and squirrels) and only trigger on large objects in the scene, if desired.

The detection of appearance events allows the system to begin triggering on objects that are discovered within the scene. In many instances, however, the mere detection of an appearance is not sufficient. As an example, the viewing audience might only be interested in video clips of people walking towards the camera, but not away from the camera. This might be of interest when facial features are important, or a frontal view of persons is desired. In these examples, analysis of the objects detected in the scene must be undertaken.

Tracking object motion within a scene can be accomplished using a variety of different methods. One of the first and foremost methods can be estimating the motion of an object as the change in position of the object over time. As an example, with change-based methods, “blobs” of detected pixels that denote different pixels from the background can be aggregated into a single entity that is called an object with no additional information. Tracking the centroid of such a blob can result in multiple position measurements over time, which in turn can be used to compute velocity and, therefore, motion. This sort of approach works best with objects that are distant from the camera and are easily identified from the background.

Stereo methods provide a stronger approach for determining object velocity, since the true three dimensional position of an object can be recovered with stereo. This, in turn, can be used to better determine the velocity of the object.

Optical flow methods are the preferred method of measuring object motion. Optical flow techniques correlate pixel-based feature information over time and directly measure pixel motion in the image domain. This can be used to provide a more definitive method for measuring object motion when compared with “blob” based techniques. In combination with stereo methods, flow-based methods can provide the best information for both target absolute position and target movement within the scene.

Detecting changes in the scene and the entrance of objects is the principal method that the system uses to aggregate meaningful content, in comparison to blind clip capture and frame grabs that do not have visual motion as a cue. More meaningful dynamic events can be used to discriminate the movement of the objects within the environment when dynamic behavior is important to the viewing audience.

In other situations, it might be desirable to be able to trigger on specific types of objects within the environment. Cues might be relevant base on color, size, the generic type of the object, and other such cues. Thus, when the viewing audience demands content related to specific object types (e.g., through microchannel creation or database query), these cues are important. Below, some basic cues for object types are defined with high-level descriptions of how those object may be identified.

Object size can be defined based on two dimensional object size as defined in scene pixels, and three dimensional size determined through absolute measurements. Image-based two dimensional (silhouette) size information is useful when the camera orientation and distance to objects is known. This information can be put into the camera system's subscription information when the camera is subscribed as a capture system 202.

Full three dimensional recovery of size information usually requires stereo methods, or other direct measurement of range and three dimensional shape. This is most easily recovered through stereo vision, as mentioned earlier. Other methods can also be used, such as ultrasound, depending upon the capabilities of capture system 202.

There are a wide variety of different object types that can be defined and detected. Usually, object types are determined through the motion that the object exhibits, rather than direct object recognition methods that attempt to fully characterize the object based on its visual appearance in any given frame. Perhaps the broadest classes of object types based on motion are rigid and non-rigid. Rigid objects are used to describe objects such as vehicles and other inanimate objects. Non-rigid motion can fall into separate sub-categories such as articulated motion (rigid bodies attached to fixed joints that can themselves move) and totally non-rigid motion (such as that associated with blowing leaves). Using rigidity and other motion constraints, it is possible to infer the types of objects within a scene and use these inferred object types as triggers for capture and cues for database retrieval.

A broad set of different technologies have been used to determine color information about an object. Most of these methods rely on the distribution of color in the object, based on the magnitudes of wavelengths of detected motion. Any of the possible color spaces and color representations can be used to describe color information for the object.

Texture is another object characteristic that can be used for indexing, retrieval, and for cuing the capture system. Texture is usually represented through the energy of the visual information at different frequency bands, orientations, and phases.

Triggers within the system should be defined such that the capture units can capture appropriate content for the aggregated video channels. Simple motion and object cues themselves may not be sufficient for most applications where aggregated content is required since there is no regulation of the scene that the camera is viewing. In the system architecture, it is the combination of all of the cues together that can provide the power for aggregating video.

The triggers themselves define when the capture systems grab video clips for transmission to the video distribution system 204. They are defined most simply as boolean combinations of events, object characteristics and activity, in combination with domain knowledge about the camera (e.g., content designation, location, etc.).

For example, assume that a video channel should be aggregated based on the presence of humans in New York City who are wearing yellow clothes. The set of cameras that are eligible for providing content for this channel must be located geographically in New York City and be in a location where humans are expected. It is preferable that the people are walking towards the camera in order to provide a frontal view, although this is not required. It is further desired that the distance of humans to the camera is below a certain range, so high resolution clips of the people can be captured. In addition, if there is the possibility of vehicular traffic in the area, it is desirable to have non-rigid, articulated motion being used to cue the triggers rather than rigid motion associated with vehicles. Color is another cue that is important for the objects. As a summary, the following trigger combination could be defined: (i) cameras that are located in New York City; (ii) cameras that are intended to look at individuals on sidewalks and within building; (iii) objects that exhibit non-rigid, articulated motion; (iv) objects that are within a maximum range from the camera; and (v) objects that have “yellow” as the dominant color.

These cues are sufficient to aggregate a microchannel. The resulting video has a high probability of having the type of content that is desired by the viewing audience. Triggering need not be perfect, since the viewers most likely are willing to tolerate less meaningful content in many instances, and a simple user screening process can eliminate most undesired clips.

The basic triggers (color, object rigidity, distance from the camera, etc.) are even meaningful for content aggregation without the associated knowledge of the camera domain (location, intended viewing content, and so on). This feature provides for a very flexible and dynamic system.

Referring to FIG. 2 again, there is shown the video capture and distribution system 200 As described above, the capture systems 202 recognize events and compress small sequences or clips of video for transmission to the video distribution system 204, which is capable of simultaneously archiving the clips into database 208 as well as aggregating the clips through time multiplexing into a video stream for a microchannel video output. During times of low content being provided from the video capture systems 202, clips from the database 208 meeting the criteria of the microchannel may be used to fill gaps when other content is not available.

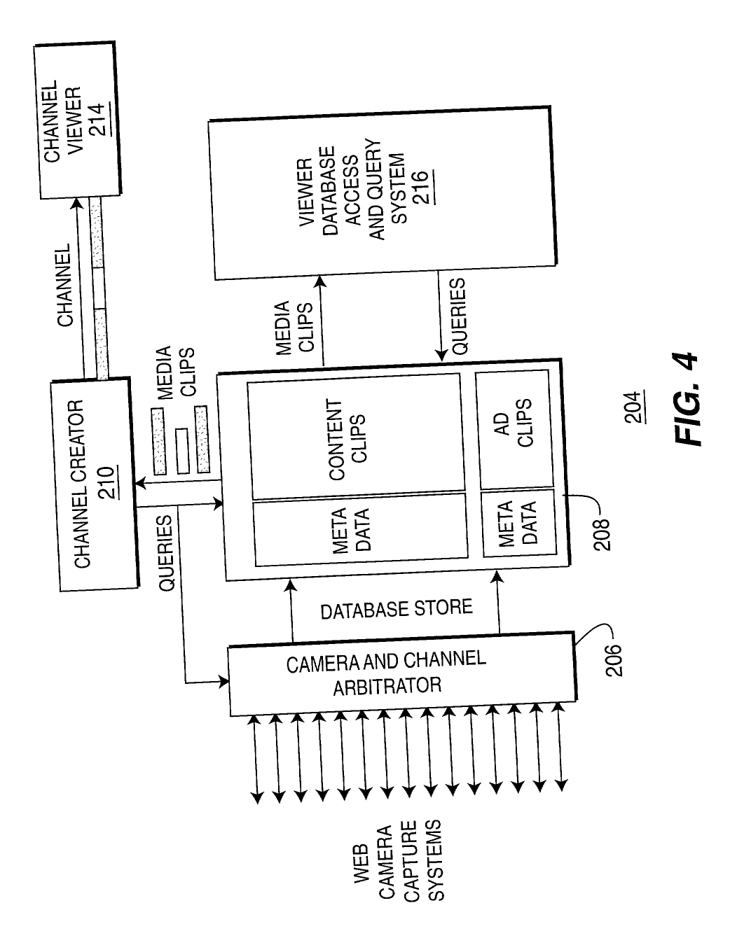

Referring to FIG. 4, there is shown a diagrammatic representation of the video distribution system components. Web camera capture systems 202 send an indication of captured clip (video or still image) availability to a camera and channel arbitrator 206. This arbitrator decides whether or not to store the clip into database 208. Databasing provides for metadata and content clips from capture systems 202, as well as preferably provides advertisement related metadata and advertisement clips. A channel creator or aggregator 210 places queries into the database which result in clips being retrieved, which are then combined, such as concatenating the clips by time multiplexing) into a stream of video and/or images. The concatenated stream may be considered a microchannel and be viewed by a channel viewer 214. The channel viewer 214 represents generally a media player such as WINDOWS MEDIA PLAYER or Real Network's REAL PLAYER being run on a user terminal 110. The user terminal may be considered the client 212 (FIG. 2) or access the video stream through a client web portal or server that generates a web page. Viewers are preferably presented the option to either view the concatenated stream of video and/or images (e.g., a microchannel) or making specific queries into the database, as described below.

All of the functions illustrated in FIG. 4, except for the channel viewer 214, are preferably provided by a server computer system designed for database and Internet service providing. Many systems for Internet services have been developed for high-capacity Internet information services. Database systems such as Orcale8i and Sybase can handle large amounts of multimedia content and retrieval using structured query language (SQL). The computer hardware itself may include redundant arrays of independent disk (RAID) storage for reliable data handling. The camera and channel arbitrator 206 is handled through software layers that interact with the database 208, as is the channel creator 210.

All capture system interaction with the camera and channel arbitrator 206 is performed using the Internet as the preferred method for communication, as shown by FIGS. 2 and 3. Internal communication between software components within the system is dependent on the architecture. Communications with the channel viewer 214 (running on a client terminal) and database browser 216 are preferably accomplished through the Internet.

As described above, microchannels created by the channel creator 210 may be defined by a set of triggers and metadata characteristics in an almost limitless number of combinations. Microchannels themselves are preferably associated with a URL that provides the “backdrop” for the video viewer. This URL is coordinated in advance with the web server or client to receive the streaming video and/or images and pass them to the end user with other Internet content.

Before transmission of a clip from a capture system 202 to the video distribution system 204, the capture system 202 preferably indicates to the camera and channel arbitrator 206 that a clip has been captured. This information datagram may include the camera identifier, camera type and other attributes of the camera, time and date of the captured clip, length, size and type of the clip (e.g., video, video and audio, still image, mosaic), and triggers used to detect the clip. Of course, some of this information need not be transmitted if it has been provided in the subscription process, i.e., it may be retrieved by arbitrator 206 locally. Using this information, the arbitrator 206 accepts or refuses the transmission of the clip. If a clip is desired by the arbitrator 206, arbitrator 206 sends an acknowledge with additional descriptor information for the clip that the capture system 202 may use when transmitting the clip to the video distribution system 204. This descriptor can be a simple numeric tag or a more sophisticated, unique identifier that is used to index the clip rapidly into database 208.

Once the acknowledge is received, the capture system 202 sends the clip to the video distribution system 204 with the unique identifier that has been provided. This upload to the server works as fast as the Internet connectivity between the capture system 202 and the video distribution system 204 provides and does not need to be real-time. Once the transmission of the clip is complete, the capture system 202 sends and end-of-transmission datagram which should be acknowledged by the arbitrator 206. It is assumed that some lossless protocol, such as TCP, is used to send the clips. If connectivity is lost during the transfer, the arbitrator 206 preferably discards the clip after some predefined amount of time and ceases to respond to the transmission from the capture system 202 about the clip. Likewise, the capture system 202 aborts the attempted transfer of a clip in the presence of communication problems.

Once the server successfully receives a full clip, the clip is committed to the database 208 for storage. This, in turn, makes the clip available for appropriate microchannels that require the type of content included within that sort of clip.

The camera and channel arbitrator 206 is responsible for managing the receipt or denial of video clips being transmitted. This subsystem of the distribution system 204 monitors the availability of video content with different attributes, and emphasizes the receipt of certain types of content that are responsive to the needs of the microchannel. Very sophisticated algorithms can be employed for this type of scheduling-for-demand problem, but the simplest implementation is likely to respond directly to the rough profile of the microchannel being employed. Thus, if the camera and channel arbitrator 206 is being overwhelmed with data of a certain type, while other microchannels are lacking enough information, some clips from capture systems 202 providing that type of data are refused when the capture systems 202 indicate that they have additional clips for transmission. This feature frees up bandwidth for the receipt of clips for the channels that require content.

The database 208 for storing clips may be a conventional relational object-oriented database. The schema for the database includes fields incorporating the camera information, data identifying the content of the clips, and the clips themselves. Most of the indexing is performed based on the queries relating to the camera itself. This can be managed through SQL or similar sorts of database queries. Since these queries are text-based, they can be optimized by the database for fast retrieval. This is the first echelon of searching of the database 207 that can occur. Secondary queries, based on the first echelon of queries, can further refine the searching to identify clips from the specific types of cameras that have certain attributes.

In the database schema, the clips are identified by their type of media, length, data size, content information, trigger information, and so on. The database does not necessarily store metadata information about each frame; rather, it preferably stores only clip-level information for the queries. This enables fast searching of clips and identification of candidate clips through fast text-based searching.

The object-orientation of the database may be used in several ways. Descriptors, such as camera identifiers and descriptions do not have exhaustive fields that are specified. Different cameras could have more or fewer descriptors that are rather free form. The object orientation of the database enables queries and searches based on these more abstract data structures and descriptors. Object orientation also may be used to store different types of media within the same database schema. Objects are used to represent video, audio, mosaics, and so on in a similar fashion in the database. This provides maximum flexibility for the database 208 as media from the capture systems 202 continues to populate the database with new types of information, especially if that type of information was not anticipated during the design of the database. Three dimensional video, stereo video, and other such representations might fit into this category.

Each microchannel has associated with it a channel creator 210 which aggregates clips into a concatenated stream that is output to the host web server (e.g. client 212) that distributes the video content to viewers. The following steps may be accomplished to create and distribute the microchannel. As described above, clips are sent to the video distribution system 204 from the capture systems 202. Clips that are received by the system 204 are “posted” to the channel creators 210. In essence, the channel creators 210 are informed that a new clip has been logged into the database 208 which might be relevant to the particular microchannel's content definition, based on an initial top level parsing of the metadata describing the camera and its associated clip. These clips are posted to channel creators 210 with indices that allow each channel creator to rapidly access that clip in the database 208. The availability of an individual clip to channel creator 210 may, if desired, be for a fixed period of time only. In essence, every clip need not be archived in database 208 as available to a channel creator 210 for longer than the fixed period of time. For example, a clip (or every other clip, or other selected pattern) may be made available to the channel creator for five minutes. After the five minutes passes, whether the clip is used by the channel creator 210 or not, the clip is no longer available from database 208. To that end, the database 208 may be considered to include the temporary memory of the distribution system 204. This feature may help preserve memory space in a database 208.

Next, the channel creators 210 determine if the clips should be used, or if another clip is needed from the database 208, based on the desired profile of the content on the microchannel. Access to other clips in the database likely occurs when there are no more appropriate “posted” clips awaiting transmission over the microchannel, as might occur, for example, with a beach microchannel at night. Some or all of the beach cameras may be located in geographic locations where it is nighttime.

The channel creator 210 then accesses the individual clips from the database 208 and creates the continuous stream or “microchannel.” The continuous stream is defined by a concatenated stream of output, whether it be a series of images, video and audio, or other forms of media. Appropriate streaming protocols and updating mechanisms that are commercially available are used as the protocols and video formats for the stream. The stream is served to the client 212 (e.g., hosting web server) through the Internet.

The microchannel creator 210 makes the following decisions when creating a microchannel: (i) what type of media should be sent at a given time (video, audio, image); (ii) what triggers should be given priority, assuming multiple triggers are defined for the microchannel; (iii) when advertising should be inserted into the video stream, and what advertising should be provided; and (iv) when the database 208 should be accessed for pre-recorded clips that are not currently posted to the microchannel as new clips. The channel creator 210 runs via decision algorithms that are determined by the desired channel content for the microchannel. This is best illustrated by example. Considering a hypothetical travel-related site, the following type of microchannel might be desired: (i) commercials should be presented once per minute in ten second maximum durations; (ii) uniform distribution of video, video and audio, still images and mosaics of different locations; (iii) emphasis on video content using activity triggers on beach cams and urban cams; (iv) emphasis on mosaic content using periodic triggering without motion for panoramic cameras; (v) emphasis on still image content for interior cameras, such as restaurant cameras; (vi) live, real-time clips during daylight hours; and (vii) pre-recorded clips during night hours when beach activity has ceased.

The implementation of the channel creator 210 can be done completely in software which interfaces to the postings of the clips and the database 208. The clip posting mechanism can be a prioritized queue of entries, with indices into the database 208, which can be supplemented by the channel and camera arbitrator 206 and deleted by the channel creator 210. The database 208 responds to queries from the channel creator using standard SQL and native implementations of SQL-like calls. Most database systems provide native code implementations of SQL in Java, C/C++, and other high level languages.

The channel creator 210 should work faster than the output streams are transmitted in order to provide seamless operation. The database 208 and the clip posting mechanism enable this to occur. Final stream output can be succinctly scheduled in advance using indices into the database that are small and easy to store and transfer. Only at the output stage of the channel creator 210, when the stream is created and transmitted, does the entire clip of media need to be manipulated. It is possible that a minute or more of delay/latency can be introduced into the channel creator 210 to provide buffering. This provides some elasticity for the output stream, enabling variability in database demands and system performance to be handled without interruption of the channel service.

The channel creator 210 also preferably manipulates a usage database to indicate measurements of when content is shown and on what microchannels for revenue generation and royalty payment purposes. The channel creator 210 may also be programmed to respond to user feedback in real-time to better serve the desires and demands of the viewers. In this manner the channel creator 210 can re-prioritize clip selection based on user feedback, thereby dynamically adjusting the microchannel to user preferences. Other external factors (such as the number of click-through) can also be used to determine where the viewers' interests lie, and that information can be used to adjust the microchannel's selected content.

The modularity of the software implemented in system 200 and the database modules within the server architecture enable great flexibility in the physical implementation of the system 200. It is quite possible for the entire video distribution system 204, including channel creator 210 and databases 208, to be resident within one physical server. It is also possible to distribute the various components over a wide physical area, where the components are logically linked using the Internet, wide area networks, or some other means for communication. Because it may be unreasonable to demand that all capture systems 202 have broadband connectivity to the Internet, and, more specifically, to the video distribution system 204, there is preferably no necessity for the capture system to provide the clips at video rate or even at real-time; rather, the clips can be “trickled” to the server with the available bandwidth. With a plurality of capture systems 202 transmitting clips at less than real-time, the standard Internet bandwidth available today is suitable.

The distribution systems 204 can provide microchannel content in a plurality of different ways. One method is to have a communications channel between the distribution system 204 and the end user terminal 110. Numerous companies are providing redundant servers that are geographically distributed with dedicated links between them that provide high quality service to many areas through dedicated distribution channels until the “last hop” to the viewer. Another method for distribution is for the video server to send streaming microchannel data to the client website that hosts the microchannel for redistribution to the user through the client website. This is an option for websites that already use Internet data caching or other methods to provide high service quality. It is also possible for the microchannel to be outputted as multiple streams depending on the quality of service that is available to the viewer. For example, some systems determine the bandwidth between the server and the viewer and scale the data throughput to be manageable on that bandwidth. For Internet viewers with little bandwidth, the microchannel could be limited still imagery and audio only, thereby placing lesser demands on the data channel. For Internet viewers with more bandwidth, the system can provide full motion video and multimedia.

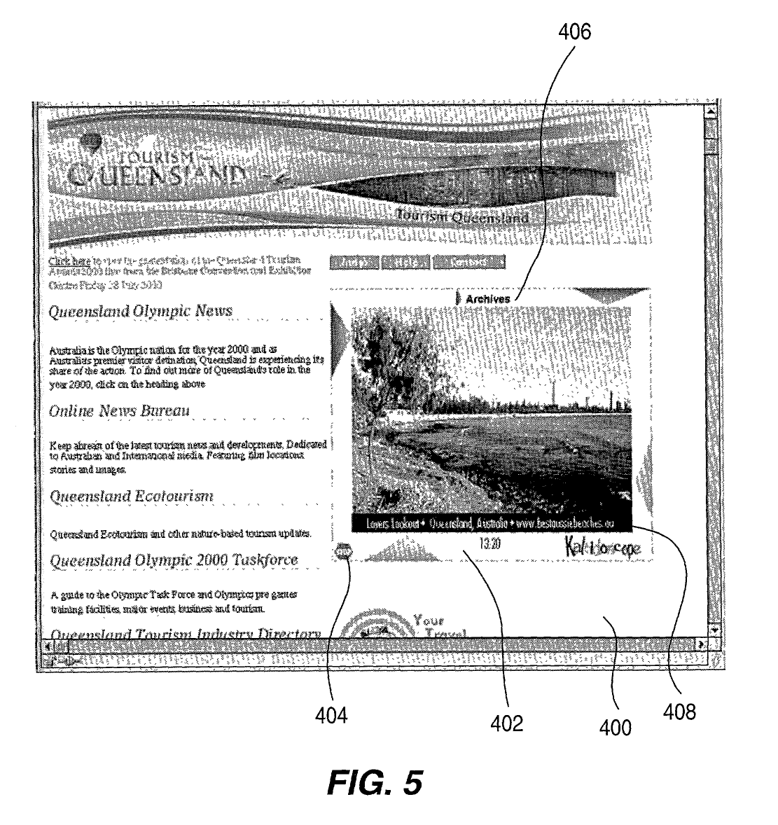

The preferred implementation of the viewer is for the microchannel to be displayed within the frame of a larger web page which contains other content and advertising (e.g., a branded web page). Referring to FIG. 5, there is shown an exemplary example of a web page viewer 402 in a branded web page 400. The viewer window 402 displays a microchannel as described above.

The hosting website could, optionally, launch a separate window for the microchannel. The advantage of the external window is that the window is sustained even while other web browsing occurs via the browser. This is sometimes desirable since advertising and other information can be provided even while the user is web surfing.

The viewer preferably works as described hereafter. Media content is shown in the constantly updating window 402. If the user “clicks” or otherwise selects on the microchannel display (such as on hyperlink 408), the web browser automatically launches, through a hyperlink, to the URL of the website that is associated with the capture system whose content was selected (described the during subscription process). In the case of an advertisement, the hyperlink goes to the URL associated with the advertisement product or company.

As can be seen within the microchannel frame in FIG. 5, there are options to stop the channel viewing and launch to the archives. The STOP button 404 halts the viewing of different channel content clips from the different camera sources and leaves the current frame (or video clip, or other non-separable media) shown in the window. This is provided so the viewer can look at the particular content without having it automatically update. The user can, therefore, more carefully traverse the hyperlink to the capture or advertisement source.

The ARCHIVE button 406 provides a second interface (not shown) to interact with the microchannel and server database. The ARCHIVE interface feature preferably enables the viewer to select certain clips from the database 208 that were associated with the microchannel. Some possible options with which the user may be presented are described hereafter. These options and the execution of a selected query may be defined and performed by the viewer database and access query system 216 (FIG. 4) of the video distribution system 204

The user may be presented with a “programming schedule” feature which lists for the user which clips have been shown during a prior period of time. The clips are preferably presented in a scrollable format along with thumbnail images, although other presentation formats may be utilized. The user can select a download of the clip by simply clicking on the thumbnail.

The user is also preferably presented with a “search” option which presents the user with a series of selection criteria to search the database 208 for a given type of clip presented in the microchannel. Only content that was provided on that particular microchannel is preferably accessible by the viewer, although this is not a requirement. Search criteria may be defined by the microchannel during its creation and overlap the triggers for the microchannel. When a search is initiated, sample clips are preferably shown as thumbnails on the web page that can be selected by the user. The user can then select clips from the thumbnail views for download.

The user is also preferably provided with an “Annotation” option which enables the user to make comments about a particular clip. This option may allow, for example, the user to rate the clip (e.g., 1-10 for very bad to very good), provide comments that are free-from text, and other dialog boxes, radial buttons, or other graphical user interfaces that allow the user to add additional information to the stream. These annotations are then transmitted to the video distribution system 204 and appended to the database for retrieval by others who can add their own annotations. It should be apparent that the actual formatting of the options presented to the user can take on many possible forms, as long as the desired functionality is provided.

Revenue from the system 200 may be generated in the following manner. A microchannel may be provided by the operator of the video distribution system 204 to a branded portal. A percentage of revenues that are generated by the branded portal may be paid to the operator of the video distribution system 204 based upon the negotiated amount of value added to the overall website by the video content. In addition, since video is attributed to specific capture systems 202, it is possible to track the popularity of specific pieces of video content on the web sites.

A portion of the revenues paid to the video server operator may then be passed onto the owners or operators of the web cameras in recognition of the generation of meaningful video content. The database 208 and channel creator 210 have the ability to provide an audit trail showing when the clips were displayed on which channels. This data can be cross-referenced with data from the web camera sources. An example of a royalty model for compensating camera operators may be to base the royalty on the percentage of content time contributed by each camera to a channel, multiplied by a revenue value associated with that channel.

Cameras that provide very popular content that is aired frequently, therefore, receive a proportional amount of payment as compared to the airtime for that channel's content. Also, the payment is proportional to the weighted value for that channel. These two factors provide a fair payment for very popular web cameras that are shown on very popular channels. This, in turn, encourages web camera operators to improve the quality of their content and rewards those who have well placed cameras for specific types of content. User ratings are another metric that might be used in order to determine revenue share as well as continually define the “microchannel community” interests.

The databasing capabilities, especially with the relational capabilities, make it easy to itemize the royalty payments for each capture system 202. Over a fixed duration, such as a month or a week, the total programming is itemized and a table is created and sorted by web camera, airtime, and channel where the content was aired. This table is then itemized with the primary key of the web camera, with secondary columns associated with individual clips and each of their individual airings on each channel. Separate tables in the database (which are trivial to create) can contain the web microchannels themselves and their associated revenues values. Relational relationships enable itemized results by web camera, by operator, by channel, or by other primary keys.

As mentioned, advertisements may be provided within each microchannel in response to paid-for advertising time paid to the video server operator. The format of the ad content is variable and depends on the medium associated with the microchannel itself. It is desirable to have video advertisements, but audio and still images may also be utilized.

Advertisements are stored in an advertisement database which may or may not be separate from database 208. The advertisement database may contain information such as the ad sponsor name, address and sponsor's URL, the digital media associated with the advertisement itself, an identifier for the microchannel(s) where the advertisement is to be displayed, a time stamp for the last time the advertisement was played in each microchannel, the number of times per day the advertisement is to be played in each microchannel, and the preferred pre and post-advertisement clips that should be played for each microchannel. The microchannel creator 210 preferably is responsible for monitoring the advertisements that are to be displayed on each microchannel and inserting the advertisement into the channel at the appropriate times.

Very powerful targeted advertising can be accomplished through coordinating the display of the content and advertising in a cooperative manner. For example, the manufacturer of surf boards might want to have the surf boards advertised close in proximity in time to the display of beach camera clips, while a restaurant operator may prefer to have restaurant advertisements displayed close to the display of the content of urban or leisure cameras. Such coordination can be accommodate through specific tags in the advertising database that show preferred locations for the advertisements.

Advertisement revenue can be determined with the same audit method that is provided for reimbursing capture system operators. Other statistics, such as click-through and total ad time on the microchannel, can also be computed for performance purposes.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although various embodiments of the present invention have been illustrated, this is for the purpose of describing, but not limiting the invention. Various modifications which will become apparent to one skilled in the art, are within the scope of this invention described in the attached claims.

What is claimed is:

1. A method of capturing and distributing media content through a computer network, comprising the steps of:
comparing a plurality of clips of media content captured with at least one capture system against a set of trigger criteria, said trigger criteria defining at least one type of media content which is to be transmitted to a distribution system;
identifying clips from said plurality of clips which satisfy said trigger criteria;
transmitting said identified clips to said distribution system through said computer network;
combining a plurality of said clips into a microchannel stream, each of said combined clips being associated with criteria from said trigger criteria that overlap at least a portion of microchannel criteria, said microchannel criteria defining at least one type of media content to be included in said microchannel stream; and
transmitting said microchannel stream to at least one client through said computer network.

2. The method of claim 1, further comprising the step of subscribing each of said at least one capture system to said distribution system.

3. The method of claim 2, wherein said step of subscribing comprises the step of receiving with said distribution system data identifying each of said at least one capture system and data identifying trigger capabilities for each of said at least one capture system.

4. The method of claim 3, further comprising the step of transmitting at least one set of triggers for said at least one capture system from said distribution system through said computer network to said at least one capture system in order to direct said at least one capture system to transmit clips of media content of a type identified by said at least one set of triggers.

5. The method of claim 4, wherein said step of transmitting said at least one set of triggers is in response to a need for new media content to populate a microchannel.

6. The method of claim 4, wherein said step of transmitting said at least one set of triggers is in response to a request received from said client.

7. The method of claim 1, further comprising the step of transmitting advertisements within said microchannel stream.

8. The method of claim 7, wherein said advertisements are transmitted proximate in time to clips of media content related to said advertisements.

9. The method of claim 1, wherein said trigger criteria include an occurrence of an event, a characteristic of said event, a characteristic associated with said at least one capture system, or a combination thereof.

10. The method of claim 9, wherein said clips are video clips, still image clips, mosaic clips, audio clips or a combination thereof.

11. The method of claim 10, wherein said event includes an appearance of an object in a scene, a disappearance of an object in a scene, motion of an object in a scene, or combination thereof, and said characteristic of said event includes a time said event occurred, a location of a capture system, a type of content being captured by a capture system, a description of said event, a size of an object in a scene, a type of an object in a scene, a color of an object in a scene, a texture of an object in a scene, a direction of motion of an object in a scene, or a combination thereof.

12. The method of claim 1, wherein said client is a web server that transmits a web page including said microchannel, said method further comprising the steps of charging a monetary fee for transmitting said microchannel stream to said web server over a period of time, identifying any capture systems which provided clips that were included within the microchannel stream served over said period of time, and crediting operators of said identified capture systems a proportional amount of said monetary fee, said proportional amount determined at least in part by the proportion of the total microchannel stream provided by each of said identified capture systems over said period of time.

13. The method of claim 1, further comprising the steps of storing said transmitted clips in a database along with data identifying a respective capture system which transmitted each of said transmitted clips and data identifying respective criteria from said trigger criteria which each of said clips satisfied.

14. The method of claim 13, further comprising the steps of receiving a query from a client to search said database for clips having identified criteria, identifying at least one clip satisfying said query, and transmitting said at least one clip satisfying said query to said client through said computer network.

15. The method of claim 14, wherein said identified criteria is selected from microchannel criteria defining a microchannel transmitted to said client.

16. The method of claim 13, further comprising the steps of receiving with said distribution system an annotation regarding a clip within a transmitted microchannel stream and storing said annotation in said database.

17. A system for capturing and distributing media content over a computer network, comprising:
at least one capture system, each of said at least one capture system including a capture unit for transmitting clips of media content captured by said capture system to a distribution system through said computer network, said media content characterized by trigger criteria identified by a set of at least one trigger which defines for said capture system at least one type of media content to be transmitted to said distribution system; and
said distribution system, said distribution system receiving said clips transmitted from said at least one capture system, said distribution system comprising:
at least one microchannel creator, said microchannel creator combining a plurality of said clips into a microchannel stream, each of said combined clips being associated with criteria from said trigger criteria that overlap at least a portion of microchannel criteria, said microchannel criteria defining at least one type of media content to be included in said microchannel stream,
wherein said distribution system transmits said microchannel stream to at least one client through said computer network.

18. The system of claim 17, wherein said distribution system further comprises a database, said database including a plurality of clips received from said at least one capture system along with data identifying a capture system which transmitted each of said transmitted clips and data identifying criteria from said trigger criteria which identifies the media content of each of said clips, and wherein said microchannel creator creates said microchannel stream at least in part from clips in said database.

19. The system of claim 18, wherein said distribution system further comprises a viewer database query and access system, said query and access system identifying at least one clip from said database in response to a query identifying search criteria and received from a client, said query and access system transmitting said at least one clip to said client through said computer network.

20. The system of claim 19, wherein said search criteria is selected from said microchannel criteria.

21. The system of claim 17, wherein said distribution system further comprises a channel arbitrator, said channel arbitrator communicating with each of said at least one capture system to subscribe said at least one capture system to said distribution system, said channel arbitrator receiving data identifying said at least one capture system and data identifying trigger capabilities of said at least one capture system.

22. The system of claim 21, wherein said channel arbitrator communicates with said at least one capture system to reconfigure said set of at least one trigger defined for said at least one capture system.

23. The system of claim 22, wherein said channel arbitrator reconfigures said set of at least one trigger in response to a need of said at least one microchannel creator for clips of new media content.

24. The system of claim 22, wherein said channel arbitrator reconfigures said set of at least one trigger in response to a request received from a client.

25. The system of claim 17, wherein said at least one microchannel creator retrieves advertisements from a database and provides said advertisements within said microchannel stream.

26. The system of claim 17, wherein said trigger criteria include an occurrence of an event, a characteristic of said event, a characteristic associated with said at least one capture system, or a combination thereof.

27. The system of claim 26, wherein said clips are video clips, still image clips, mosaic clips, audio clips or a combination thereof.

28. The system of claim 27, wherein said event includes an appearance of an object in a scene, a disappearance of an object in a scene, motion of an object in a scene, or combination thereof, and said characteristic of said event includes a time said event occurred, a location of a capture system, a type of content being captured by a capture system, a description of said event, a size of an object in a scene, a type of an object in a scene, a color of an object in a scene, a texture of an object in a scene, a direction of motion of an object in a scene, or a combination thereof.

29. The system of claim 17, further comprising at least one client which is a web server.

30. The system of claim 29, wherein said web server transmits a web page including said microchannel, said distribution system further comprising means for identifying any of said at least one capture system which provided clips that were included within a microchannel stream transmitted over a period of time to said web server and means for identifying a proportion of said total microchannel stream provided by each of said identified at least one capture system over said period of time.
